(19) United States
(12) Patent Application Publication
(10) Pub. No.: US 2007/0222836 A1
(43) Pub. Date: Sep. 27, 2007

(54) Ink cartridge and method of fabricating the same

(75) Inventors: Jung-wook Kim, Yongin-si (KR); Jae-cheol Lee, Hwaseong-si (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/518,930

(22) Filed: Sep. 12, 2006

(30) Foreign Application Priority Data
Mar. 22, 2006 (KR) 2006-26162

(51) Int. Cl. B41J 2/175

(52) U.S. Cl. 347/86

(57) ABSTRACT

An ink cartridge of an inkjet printer includes at least one ink tank, at least one negative pressure adjusting part, an ink channel unit, and at least one print head having nozzles, wherein the ink channel unit is surface-treated by an ion assisted reaction (IAR) before being assembled.

### CROSS-REFERENCE TO RELATED APPLICATIONS

This application claims the priority under 35 U.S.C. § 119 from Korean Application No. 10-2006-26162, filed Mar. 22, 2006, in the Korean Intellectual Property Office, the entire content of which is incorporated herein by reference.

### BACKGROUND OF THE INVENTION

1. Field of the Invention

The present general inventive concept relates to an ink cartridge usable in a printing apparatus such as an ink jet printer, and more particularly, to an ink cartridge in which an ink passage is restrained from being blocked by air bubbles, and a method of fabricating the same.

2. Description of the Related Art

Generally, an inkjet printer ejects minute droplets of inks onto desired positions on a printing medium such as a paper, a textile fabric, etc., and thus prints a desired image of certain colors on a surface of the printing medium.

A conventional inkjet printer includes an ink cartridge that prints the desired image while reciprocating in a direction perpendicular to a conveying direction of the printing medium (e.g., a printing paper), i.e., in a width direction of the printing paper. However, the conventional inkjet printer in which the ink cartridge prints the desired image while reciprocating, as described above, is disadvantageous in that a printing speed thereof is slow.

Recently, an inkjet printer employing an ink cartridge which is equipped with a plurality of print heads arranged all along the width direction of the printing paper has been developed, thereby printing the desired image at a high speed without reciprocating. The inkjet printer having the plurality of printheads arranged all along the width direction of the printing paper is called an array print head type inkjet printer.

A conventional array print head type ink cartridge includes a plurality of ink tanks to store inks for printing, a plurality of negative pressure adjusting parts connected to the ink tanks, respectively, a plurality of print heads arranged in a predetermined pattern at the width direction of the printing paper, and an ink channel unit to supply the inks to the print heads from the ink tanks.

The ink tanks are mounted in a frame. The ink tanks store the inks of various colors, e.g., yellow, magenta, cyan, and black, respectively.

The negative pressure adjusting parts are fixed under the frame, so that the negative pressure adjusting parts communicate with corresponding ones of the ink tanks, respectively. These negative pressure adjusting parts produce a negative pressure to prevent a leakage of the inks.

The ink channel unit is connected with the negative pressure adjusting parts, and supplies the inks flowed in from the ink tanks through the negative pressure adjusting parts, to the print heads.

The print heads are arranged and fixed in a certain pattern along an entire surface of the ink channel unit. Each of the print heads has a plurality of nozzles to eject the inks. The nozzles eject the inks supplied from the ink channel unit onto the printing paper to print the desired image thereon.

The conventional ink cartridge having either the construction as described above or other constructions, air bubbles may be produced on a path, i.e., in an ink passage, through which the inks move from the ink tanks to the nozzles of the print heads, due to various causes.

More specifically, the ink channel unit of the conventional array print head type ink cartridge is formed by assembling channel parts made of a plastic or ceramic material with each other. The channel parts of the plastic or ceramic material are bonded and packaged by using an adhesive material, such as a sealant, having a high hydrophilic property. However, the plastic or ceramic material has a very fine chemical structure because it has to satisfy a high level of conditions of mechanical strength, thermal stability, chemical resistance, etc., which are required in the print head having a complex construction. Accordingly, it is difficult to bond the channel parts of the plastic or ceramic material having the property as described above with each other by using a conventional adhesive material. Thus, when the channel parts are bonded and packaged, structural defects are generated at portions thereof, which are not completely joined with each other, so that air bubbles may flow into the ink passage through the structural defect portions from an outside of the inkjet printhead. If the air bubbles flow into and/or accumulate in the ink passage, the ejection of the inks through the ink passage is obstructed. In the conventional array print head type ink cartridge having a complicated ink passage, a problem of an ink supply inferiority may easily occur therefrom.

### SUMMARY OF THE INVENTION

The present general inventive concept provides an ink cartridge of an inkjet printer in which surfaces of parts constituting an ink supplying unit having an improved adhesive strength and hydrophilic property, and a method of fabricating the same.

Additional and/or other aspects and advantages of the general inventive concept will be set forth in part in the description which follows and, in part, will be obvious from the description, or may be learned by practice of the general inventive concept.

The foregoing and/or other aspects and utilities of the present general inventive concept may be achieved by providing an ink cartridge usable in an image forming apparatus including at least one ink tank, at least one negative pressure adjusting part, an ink channel unit, and at least one print head having nozzles, wherein the ink channel unit is surface-treated by an ion assisted reaction (IAR) before assembled with at least one negative pressure adjusting part and the at least one printhead.

The ink channel unit may comprise at least two channel plates having ink channels formed therein to pass an ink therethrough, the at least two channel plates joined along surfaces thereof modified by the ion assisted reaction.

One of the at least two channel plates may be a pressing plate connected to the at least one negative pressure adjusting part.

The pressing plate and the other of the at least two channel plates may be joined with each other by an adhesive agent.

The at least two channel plates may be joined with each other by an adhesive agent.

The adhesive agent may comprise an epoxy sealant.

The ink channel unit may be formed of a plastic material having a predetermined portion of a liquid crystal polymer (LCP).

The LCP may be contained in at least 10% by weight.

The ink channel unit may is formed of a ceramic material having a predetermined amount of Al2O3.

The Al2O3 may be at least 10% by weight.

An ion used when the ink channel unit is surface-treated by the ion assisted reaction (IAR) may include an inert gas.

An ambient gas used when the ink channel unit is surface-treated by the ion assisted reaction (IAR) may include oxygen.

An ambient gas used when the ink channel unit is surface-treated by the ion assisted reaction (IAR) may include nitrogen.

The foregoing and/or other aspects and utilities of the present general inventive concept may also be achieved by providing a method of fabricating an ink cartridge usable in an image forming apparatus including at least one ink tank, at least one negative pressure adjusting part, an ink channel unit having a plurality of channel plates, and at least one print head having nozzles, the method including treating respective surfaces of the plurality of channel plates by an ion assisted reaction (IAR) so as to modify the respective surfaces of the plurality of channel plates, and joining the plurality of channel plates having the modified surfaces with each other.

The treating the respective surfaces of the plurality of channel plates may include cleaning the respective surfaces of the plurality of channel plates to remove dirt therefrom, placing the plurality of channel plates in a vacuum chamber, and injecting a predetermined ion beam and a predetermined ambient gas into the vacuum chamber to treat the respective surfaces of the plurality of channel plates.

The cleaning the respective surfaces of the plurality of channel plates may include cleaning the respective surfaces of the plurality of channel plates with an isopropyl alcohol (IPA) as a solvent.

The vacuum chamber may be maintained in a vacuum state of less than 10-4 torr at the placing of the plurality of channel plates in the vacuum chamber.

The predetermined ion beam may be an Ar⁺ ion and the predetermined ambient gas is O₂ gas.

A total dose of the ion beam may be at least 1×1015 ions/cm².

The predetermined ion beam is an Ar⁺ ion and the predetermined ambient gas is a N₂ gas.

The joining the plurality of channel plates may include applying an adhesive agent onto boding sides of the plurality of channel plates having the modified surfaces, layering and compressing the plurality of channel plates having the bonding sides applied with the adhesive agent, and heating the plurality of compressed channel plates so as to harden the adhesive agent.

The adhesive agent used at the applying the adhesive agent may include an epoxy sealant.

The layering and compressing of the plurality of channel plates may include compressing the plurality of channel plates through a press jig.

The heating the plurality of compressed channel plates may comprise placing the plurality of compressed channel plates at an ambient state having a temperature ranging from 80° C. to 160° C. for a predetermined time.

The plurality of channel plates may be formed of a plastic including at least 10% LCP by weight.

The plurality of channel plates may be formed of a material including at least 10% Al₂O₃ by weight.

The foregoing and/or other aspects and utilities of the present general inventive concept may also be achieved by providing an ink channel assembly, including two or more channel plates having surfaces treated according to an ion assisted reaction to be joined.

### BRIEF DESCRIPTION OF THE DRAWINGS

These and/or other aspects and advantages of the general inventive concept will become apparent and more readily appreciated from the following description of the preferred embodiment, taken in conjunction with the accompanying drawings of which:

FIG. 1 is an exploded perspective view illustrating an ink cartridge according to an embodiment of the present general inventive concept;

FIG. 2 is a cross sectional view illustrating a view taken along a line II-II of FIG. 1; and

FIG. 3 is a magnified cross sectional view illustrating a negative pressure adjusting part of FIG. 1.

### DETAILED DESCRIPTION OF THE PREFERRED EMBODIMENTS

Reference will now be made to an embodiment of the present general inventive concept, examples of which are illustrated in the accompanying drawings, wherein like reference numerals refer to the like elements throughout. The embodiment is described below in order to explain the present general inventive concept by referring to the figures.

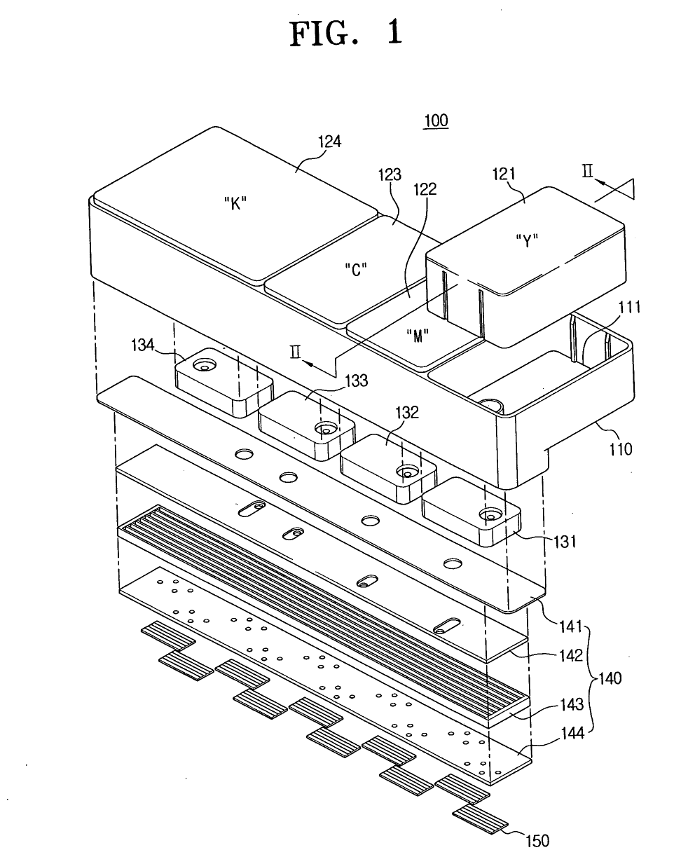

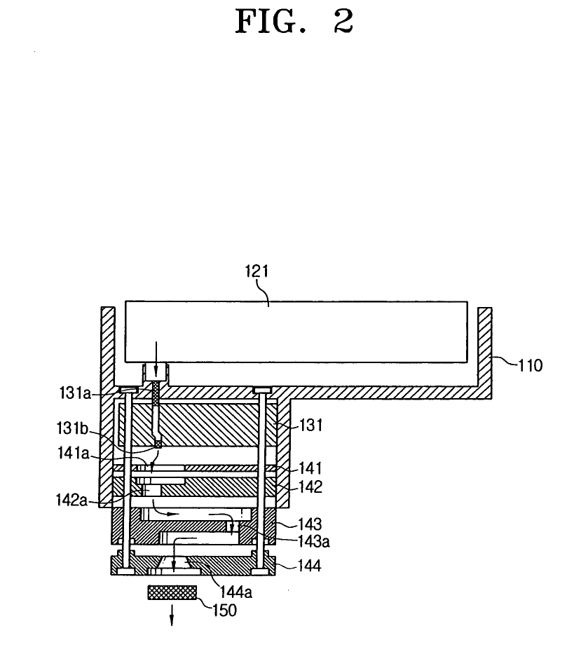

An inkjet printer is a device that ejects minute droplets of inks onto desired positions on a printing medium such as a paper, a textile fabric, etc., and thus prints a desired image of certain colors on a surface of the printing medium. FIG. 1 is an exploded perspective view illustrating an ink cartridge 100 according to an embodiment of the present general inventive concept. FIG. 2 is a cross sectional view illustrating a view taken along a line II-II of FIG. 1. Referring to FIGS. 1 and 2, the inkjet printer includes the ink cartridge 100 that stores the inks, and that ejects the stored inks through print heads 150. In an exemplary embodiment of the present general inventive concept, the ink cartridge 100, is provided in an array print head type inkjet printer, is equipped with a plurality of the print heads 150 arranged all over a width direction of the printing medium (e.g., a printing paper).

The ink cartridge 100 according to the present embodiment includes a plurality of ink tanks 121, 122, 123, and 124 to store the inks for printing, a plurality of negative pressure adjusting parts 131, 132, 133, and 134 connected to the ink tanks 121, 122, 123, and 124, respectively, the plurality of print heads 150 arranged in a predetermined pattern in the width direction of the printing medium, and an ink channel unit 140 to supply the inks to the print heads 150 from the ink tanks 121, 122, 123, and 124.

The ink tanks 121, 122, 123, and 124 are mounted in a frame 110. These ink tanks 121, 122, 123, and 124 each store a corresponding one of the inks of various colors, e.g., yellow, magenta, cyan, and black.

Tank mounts 111 are formed in the frame 110, on which the ink tanks 121, 122, 123, and 124 are mounted, respectively.

The negative pressure adjusting parts 131, 132, 133, and 134 are fixed under the frame 110 to communicate with the ink tanks 121, 122, 123, and 124, respectively. The negative pressure adjusting parts 131, 132, 133, and 134 each produce a negative pressure to prevent a leakage of the inks from the ink cartridge 100.

The ink channel unit 140 is connected (assembled) with the negative pressure adjusting parts 131, 132, 133, and 134 so as to supply the inks flowed in from the ink tanks 121, 122, 123, and 124 through the negative pressure adjusting parts 131, 132, 133, and 134, to the print heads 150.

The ink channel unit 140 is fabricated, so that a plurality of channel plates 141, 142, 143 and 144 are layered and joined with one another. Among the plurality of channel plates 141, 142, 143 and 144, a channel plate 141, which is connected (assembled) with the negative pressure adjusting parts 131, 132, 133, and 134, may be a pressing plate. For instance, as illustrated in the drawings, three channel plates, i.e., a first channel plate 142, a second channel plate 143, and a third channel plate 144 are layered down in order from the pressing plate 141. However, the present general inventive concept is not limited to this. In other embodiments, the pressing plate 141 can be omitted. Also, the ink channel unit 140 may be formed of either more than two channel plates or more than four channel plates.

In the present embodiment, the pressing plate 141 is also referred as a channel plate.

The channel plates 141, 142, 143 and 144 have channels 141a, 142a, 143a, and 144a to pass the inks therethrough, respectively. The channels 141a, 142a, 143a, and 144a of the channel plates 141, 142, 143 and 144 are arranged to communicate with one another according to each of the colors of the inks.

In an undersurface of each of the plurality of print heads 150 are formed a plurality of nozzles (not illustrated). The nozzles eject the inks supplied from the ink channel unit 140 onto the printing medium to print the desired image thereon.

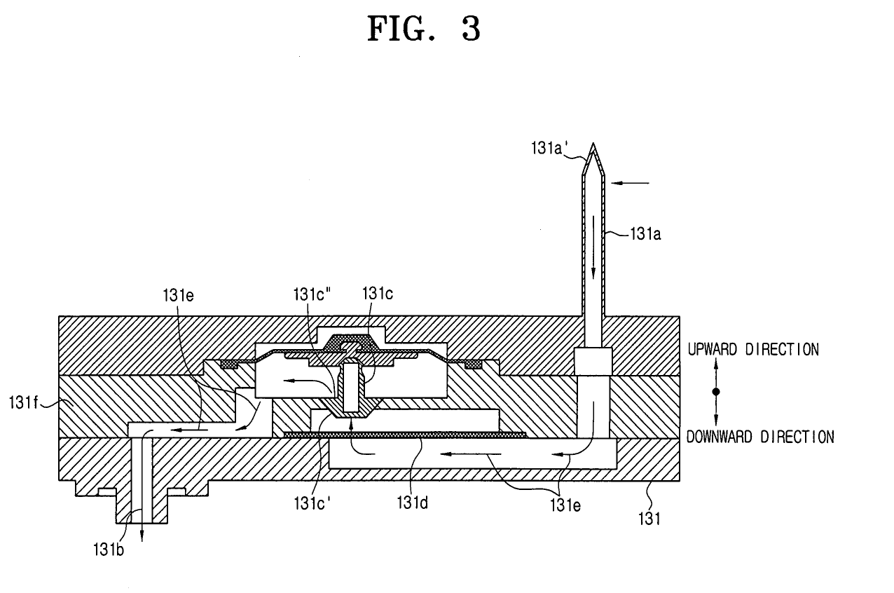

FIG. 3 is a magnified cross sectional view illustrating the negative pressure adjusting part 131 of FIG. 1.

Hereinafter, construction and operation of the negative pressure adjusting parts, e.g., the negative pressure adjusting part 131, will be described in detailed with reference to FIGS. 2 and 3.

The negative pressure adjusting part 131 includes an ink inlet needle 131a, an ink channel 131e, a valve 131c, a filter 131d, an ink outlet 131b, and a body 131f.

An ink inlet 131a′ is formed at a top end of the ink inlet needle 131a through which the ink flows into the ink inlet needle 131a.

A bottom end of the ink inlet needle 131a, at which the ink inlet 131a′ is not formed, communicates with a first portion of the ink channel 131e. The first portion of the ink channel 131e is communicated with an ink inlet portion 131c′ of the valve 131c. An ink outlet portion 131c″ of the valve 131c communicates with the ink outlet 131b through a second portion of the ink channel 131e. In the present embodiment, the valve 131c, which uses an elastic force of a spring (not illustrated), is actuated by a pressure difference between a pressure of the ink inlet portion 131c′ and a pressure of the ink outlet portion 131c″ of the valve 131c. The filter 131d is disposed between the ink inlet portion 131c′ of the valve 131c and the first portion of the ink channel 131e to remove impurities existing in the ink.

In the present embodiment, the ink inlet needle 131a and the filter 131d may be formed of a stainless steel. However, the present general inventive concept is not limited thereto, and the ink inlet needle 131a and the filter 131d can be made of other materials.

The negative pressure adjusting part 131 is operated as follows.

First, the ink drained out from the ink tank 121 of FIG. 2 flows into the ink inlet needle 131a through the ink inlet 131a′ illustrated in FIG. 3. And then, the ink drained from the ink inlet needle 131 arrives at the ink inlet portion 131c′ of the valve 131c via the ink channel 131e and the filter 131d. When the pressure of the ink outlet portion 131c″ of the valve 131c is lowered than that, i.e., the atmospheric pressure, of the ink inlet portion 131c′ of the valve 131c so as to impose a negative pressure on the ink outlet portion 131c″, the spring of the valve 131c is contracted upward by the negative pressure of the ink adjacent to the ink inlet portion 131c′. That is, the ink moves up, pushing the spring of the valve 131c. When the spring of the valve 131c is sufficiently pushed and moved up, holes (not shown), which is formed in the ink outlet portion 131c″ of the valve 131c, are exposed to the ink, and thus the ink flows out through the holes. The ink drained from the valve 131c is discharged from the ink outlet 131b via the second portion of the ink channel 131e toward the ink channel unit 140.

In the ink cartridge 100, the channel plates 141, 142, 143, and 144 constituting the ink channel unit 140 may be formed of either a plastic material in which a liquid crystal polymer (LCP) is contained by no more than 10% by weight, or a ceramic material in which Al2O3 is contained by no more than 10% by weight.

The LCP, which is made by Polyplastic Company, is a material that satisfies a high level of conditions in mechanical strength, thermal stability, and chemical resistance, etc., required in the formation of the inkjet cartridge 100.

The channel plates 141, 142, 143, and 144 each include a surface which is surface-treated by an ion assisted reaction (IAR), to change a property of the respective surfaces thereof without reducing the mechanical strength or any other material or physical properties. To be more specific, with the surface-treatment of the channel plates 141, 142, 143, and 144 by the IAR, the respective surfaces of the channel plates 141, 142, 143, and 144 are modified to have an improved hydrophilic property, so that they are easily and strongly bonded with one another by an adhesive agent with a high hydrophilic property to be described later.

After the surface-treatment, the adhesive agent is applied to bonding sides of the channel plates 141, 142, 143, and 144, and then the bonding sides of the channel plates 141, 142, 143, and 144 are bonded with one another to form the ink channel unit 140. An epoxy sealant may be used as the adhesive agent.

As described above, the channel plates 141, 142, 143, and 144 are surface-treated by the IAR, so that the respective surfaces thereof are modified to have the improved hydrophilic property and the increased adhesive force. Accordingly, when the channel plates 141, 142, 143, and 144 are joined or assembled by the bonding operation of surface-treating and then using the adhesive agent, the channel plates 141, 142, 143, and 144 are strongly bonded with one another, so that the channel plates 141, 142, 143, and 144 do not generate any gaps or bonding defects therebetween to bring about the leakage. As a result, an inflow of air bubbles into an ink passage of the ink channel unit 140 from an outside of the ink cartridge 100 is prevented.

Even though the air bubbles are generated while the inks are supplied into the ink channel unit 140 from the ink tanks, the air bubbles do not cling or accumulate in the ink passage of the ink channel unit 140 due to the surface-treatment to improve the hydrophilic property performed on the ink channel unit 140. Accordingly, a block of the ink passage of the ink channel unit 140 by the air bubbles is prevented, and the inks are smoothly and stably supplied to the print heads 150. As a result, deterioration in the quality of image printed on the printing medium is prevented.

Hereinafter, a method of fabricating (assembling) the ink cartridge 100, more specifically, the ink channel unit 140 among the components of the ink cartridge 100, will be described in detail as follows.

First, the plurality of channel plates 141, 142, 143, and 144 to constitute the ink channel unit 140 are formed, and then cleaned with a cleaning solvent to remove a pollutant or dirt from respective surfaces of the plurality of channel plates 141, 142, 143, and 144. As the cleaning solvent, an organic solvent, such as isopropyl alcohol (IPA), may be used.

Subsequently, the channel plates 141, 142, 143, and 144, the respective surfaces of which are cleaned, are placed in a vacuum chamber (not shown). At this time, the vacuum chamber is maintained in a vacuum state of less than 10⁻⁴ torr. The channel plates 141, 142, 143, and 144 are then surface-treated by an IAR process. An Ar+ ion may be used as an ion beam for the IAR process, and a total dose of the Ar+ ion beam is in a range of at least 1×10¹⁵ ions/cm².

Because the channel plates 141, 142, 143, and 144 are surface-treated by the IAR process, the respective surfaces of the channel plates 141, 142, 143, and 144 are modified to be surfaces with an improved hydrophilic property. The method of modifying the surfaces of the channel plates 141, 142, 143, and 144 by the IAR process may not change physical and/or chemical characteristics of the surfaces of the channel plates 141, 142, 143, and 144 (except for the improved hydrophilic property). Accordingly, the surfaces of the channel plates 141, 142, 143, and 144 may not be damaged. Also, the modified surface state of the channel plates 141, 142, 143, and 144 can be semi-permanently maintained.

Table 1 below illustrates results from a hydrophilic property comparison. For the comparison of Table 1, the surfaces of the channel plates 141, 142, 143, and 144, in accordance with the present embodiment, were modified to be the surfaces with the improved hydrophilic property after being surface-treated by the IAR process. Contact angles of the modified surfaces of the channel plates 141, 142, 143, and 144 to water have smaller than contact angles for surfaces of the channel plates 141, 142, 143, and 144 that have not been modified.

TABLE 1

| | Contact angle | |
|---|---|---|
| | of modified surfaces to water | |
| | Before the surface | After the surface |
| Ink channel unit | treatment | treatment |
| Channel plates | Front surfaces: 52° | Front surfaces: 19° |
| including a pressing plate | | |
| formed of plastic material in | | |
| which LCP is contained by | Rear surfaces: 52° | Rear surfaces: 18° |
| more than 10% by weight | | |

The contact angles of the modified surfaces to water were measured by a drop shape analysis system DSA10, which is made by Kruss Company.

After the surfaces of the channel plates 141, 142, 143, and 144 are modified into the surfaces with the improved hydrophilic property, an adhesive agent is applied at bonding sides thereof. In one embodiment, an automatic dispensing apparatus of Protec Company may be used to apply an epoxy sealant on the bonding sides of the modified surfaces of the channel plates 141, 142, 143, and 144.

After the adhesive agent, i.e., the epoxy sealant, is applied, the channel plates 141, 142, 143, and 144 are compressed by a press jig. While compressed, the channel plates 141, 142, 143, and 144 are heated and dried in a drying oven, which is maintained in a temperature ranging from 80° C. to 160° C., for about two hours. Accordingly, the adhesive agent, i.e., the epoxy sealant, applied onto the bonding sides of the modified surfaces of the channel plates 141, 142, 143, and 144 are hardened, so that the channel plates 141, 142, 143, and 144 are strongly bonded with one another, thereby completing the fabrication of the ink channel unit 140.

Table 2 below illustrates a leak test result comparing the ink channel unit 140 fabricated according to the exemplary embodiment and another ink channel unit 140 that was not fabricated according to the exemplary embodiment. Table 2 illustrates that the ink channel unit 140, which was fabricated by modifying the surfaces of the channel plates 141, 142, 143, 144 with the IAR process and then bonding the channel plates 141, 142, 143, 144 with the epoxy sealant according to the exemplary embodiment of the present general inventive concept generated no leakage caused by bonding defects.

TABLE 2

| | Not carrying out the | Carrying out the |
|---|---|---|
| | surface treatment | surface treatment |
| Ink channel unit (11 | Most of the 11 samples | All the 11 samples |
| samples were tested) | have generated the leakage. | have not generated the |
| | | leakage. |

The results illustrated in the table 2 were obtained by observing whether leaks caused by bonding defects in fabricated ink channel unit 140 occurred after sealing one end of the ink passage of the fabricated ink channel unit 140 and making a vacuum at an opposite end of the ink passage of the fabricated ink channel unit 140.

After the ink channel unit 140 is fabricated as described above, the ink channel unit 140 is joined to undersurfaces (bottom surfaces) of the negative pressure adjusting parts 131, 132, 133, and 134. And then, the printer heads 150 are joined to an undersurface (bottom surfaces) of the ink channel unit 140.

The ink channel unit 140 corresponds to a portion that forms a very complicated and minute path among ink paths through which the inks are conveyed from the ink tanks to the print heads 150. Accordingly, the method which assembles the surface-treated channel plates by bonding them with one another to form the ink channel unit 140 and joins the formed ink channel unit 140 to the negative pressure adjusting parts 131, 132, 133, and 134 and the print heads 150, may follow a conventional method to assemble the ink cartridge 100.

According to the results of applicant's printing test of a conventional ink cartridge fabricated by using an ink channel unit which is not surface-treated, it was observed that inks were not smoothly supplied due to air bubbles mixed already therewith and also because of air bubbles that flowed into the ink channel unit at an early stage of the printing test. However, according to results of applicant's printing test on an ink cartridge according to the exemplary embodiment of the present general inventive concept, it was confirmed that a problem associated with a conventional ink cartridge did not occur in the ink cartridge according to the exemplary embodiment.

As noted previously, although the ink cartridge according to the exemplary embodiment of the present general inventive concept has been explained and illustrated as the array print head type ink cartridge, the present general inventive concept is not limited thereto. For example, the ink cartridge according to the present general inventive concept may include embodiment usable in an ink cartridge which ejects inks onto a printing medium and which thus prints a desired image while reciprocating in a width direction of the printing medium.

As described above, according to the present general inventive concept, surfaces of channel plates of an ink channel unit are surface-treated by an IAR, and thereby modified to have an improved hydrophilic property. Accordingly, when the channel plates are bonded and assembled with one another by using an adhesive agent, the channel plates are strongly joined with one another, to thereby prevent a leak from occurring therebetween. Thus, the inflow of air bubbles into an ink passage of the formed ink channel unit from an outside thereof due to the leak or leakage is prevented, so that air bubbles in the ink passage of the ink channel unit is prevented and a blockage of the ink channel is prevented.

As described above, according to the present general inventive concept, an ink channel unit fabricated by the method as described above, the improved hydrophilic property provided to modified surfaces of channel plates and an ink passage, is semi-permanently maintained.

As described above, according to the present general inventive concept, an ink cartridge of an inkjet printer and a method of fabricating the same when surfaces of parts of an ink channel unit are modified to have an improved hydrophilic property by the method as described above, a problem of leakage does not occur, in that the surfaces of the parts of the ink channel unit are not damaged.

As described above, according to the present general inventive concept, a surface of an ink passage of an ink channel unit modified to have a hydrophilic property can fundamentally solve problems, such as an ink supply inferiority, a deterioration in an image quality thereto, etc., which result from a blockage of the ink passage by air bubbles produced by either the problems as described above or other causes.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An ink cartridge usable in an image forming apparatus, comprising:
at least one ink tank;
at least one negative pressure adjusting part;
an ink channel unit; and
at least one print head having nozzles,
wherein the ink channel unit is surface-treated by an ion assisted reaction (IAR) before assembled with at least one negative pressure adjusting part and the at least one printhead.

2. The ink cartridge of claim 1, wherein the ink channel unit comprises at least two channel plates having ink channels formed therein to pass an ink therethrough, the at least two channel plates joined along surfaces thereof modified by the IAR.

3. The ink cartridge of claim 2, wherein one of the at least two channel plates is a pressing plate connected to the at least one negative pressure adjusting part.

4. The ink cartridge of claim 3, wherein the pressing plate and the other of the at least two channel plates are joined with each other by an adhesive agent.

5. The ink cartridge of claim 4, wherein the adhesive agent is an epoxy sealant.

6. The ink cartridge of claim 2, wherein the at least two channel plates are bonded with each other by an adhesive agent.

7. The ink cartridge of claim 6, wherein the adhesive agent is an epoxy sealant.

8. The ink cartridge of claim 1, wherein the ink channel unit is formed of a plastic material having a predetermined amount of a liquid crystal polymer (LCP).

9. The ink cartridge of claim 8, wherein the predetermined amount is at least 10% by weight.

10. The ink cartridge of claim 8, wherein the predetermined amount at least 10% by weight.

11. The ink cartridge of claim 1, wherein the ink channel unit is formed of a ceramic material having a predetermined amount of Al₂O₃.

12. The ink cartridge of claim 1, wherein an ion used when the ink channel unit is surface-treated by the IAR comprises an inert gas.

13. The ink cartridge of claim 12, wherein an ambient gas used when the ink channel unit is surface-treated by the IAR comprises oxygen.

14. The ink cartridge of claim 12, wherein an ambient gas used when the ink channel unit is surface-treated by the IAR comprises nitrogen.

15. A method of fabricating an ink cartridge usable in an image forming apparatus comprising at least one ink tank, at least one negative pressure adjusting part, an ink channel unit having a plurality of channel plates, and at least one print head having nozzles, the method comprising:
treating respective surfaces of the plurality of channel plates by an ion assisted reaction (IAR) to modify the respective surfaces of the plurality of channel plates; and
joining the plurality of channel plates having the modified surfaces with each other.

16. The method of claim 15, wherein the treating of the respective surfaces of the plurality of channel plates comprises:
cleaning the respective surfaces of the plurality of channel plates to remove dirt therefrom;
placing the plurality of channel plates in a vacuum chamber; and
injecting a predetermined ion beam and a predetermined ambient gas into the vacuum chamber to treat the respective surfaces of the plurality of channel plates.

17. The method of claim 16, wherein the cleaning of the respective surfaces of the plurality of channel plates comprises cleaning the respective surfaces of the plurality of channel plates with an isopropyl alcohol (IPA) as a solvent.

18. The method of claim 16, wherein the vacuum chamber is maintained in a vacuum state of less than 10⁻⁴ torr at the placing of the plurality of channel plates in the vacuum chamber.

19. The method of claim 16, wherein the predetermined ion beam is an Ar⁺ ion and the predetermined ambient gas is O₂ gas.

20. The method of claim 16, wherein a total dose of the ion beam is at least 1×10¹⁵ ions/cm².

21. The method of claim 16, wherein the predetermined ion beam is an Ar+ ion and the predetermined ambient gas is N₂ gas.

22. The method of claim 15, wherein the joining of the plurality of channel plates comprises:
applying an adhesive agent onto bonding sides of the plurality of channel plates having the modified surfaces;
layering and compressing the plurality of channel plates having the bonding sides applied with the adhesive agent; and
heating the plurality of compressed channel plates so as to harden the adhesive agent.

23. The method of claim 22, wherein the adhesive comprises an epoxy sealant.

24. The method of claim 22, wherein the layering and compressing of the plurality of channel plates comprises compressing the plurality of channel plates through a press jig.

25. The method of claim 22, wherein the heating of the plurality of compressed channel plates comprises placing the plurality of compressed channel plates at an ambient state having a temperature ranging from 80° C. to 160° C. for a predetermined time.

26. The method of claim 15, wherein the plurality of channel plates are formed of a plastic material including at least 10% LCP by weight.

27. The method of claim 15, wherein the plurality of channel plates are formed of a material including at least 10% Al₂O₃ by weight.

28. An ink channel assembly usable in an image forming apparatus, comprising:
two or more channel plates having surfaces treated according to an ion assisted reaction to be joined.

29. The ink channel assembly of claim 28, wherein the treated surfaces have a hydrophilic property.

30. The ink channel assembly of claim 28, wherein:
the two or more channel plates comprise a first and second channel plates; and
the surfaces comprise first surfaces on the first channel plates and a second surface of the second channel plate to be coupled to the first surface of the first channel plate.
